(19) United States
(12) Patent Application Publication
(10) Pub. No.: US 2026/0198404 A1
(43) Pub. Date: Jul. 16, 2026

(54) TECHNIQUE FOR AFFORESTATION BY AERIAL SEEDING OF PELLETED PLANT SEED UNDER NORMAL PRECIPITATION CONDITIONS

(71) Applicant: SINOWAY FOREST TECHNOLOGY CO., LTD, Beijing (CN)

(72) Inventors: Xinpeng WANG, Beijing (CN); Jianpeng YANG, Beijing (CN); Guocong PANG, Beijing (CN); Xiongwei JIA, Beijing (CN); Junlin WANG, Beijing (CN)

(73) Assignee: SINOWAY FOREST TECHNOLOGY CO., LTD, Beijing (CN)

(21) Appl. No.: 19/110,436

(22) PCT Filed: Mar. 12, 2024
(86) PCT No.: PCT/CN2024/081196

§ 371 Date: Mar. 11, 2025

(30) Foreign Application Priority Data
Dec. 28, 2023 (CN) 202311824433.4

(51) Int. Cl. A01C 1/06; A01C 7/18

(52) U.S. Cl. CPC A01C 1/06; A01C 7/18

(57) ABSTRACT

A technique for afforestation by aerial seeding of a pelleted plant seed under normal precipitation conditions is provided. The technique includes: raw material preparation, raw material treatment, pelleting, drying, screening, and aerial seeding. The raw material preparation includes preparations of pelleted plant seed raw materials and seed raw materials. The preparation of pelleted plant seed raw materials includes: preparing the following raw materials in parts by volume: a red soil: 30 parts to 35 parts, a coco peat: 65 parts to 70 parts, and an organic matrix: 0 part to 5 parts. The preparation of seed raw materials includes: selecting 6 local plant seeds according to a local environment, including 2 tree seeds, 2 shrub seeds, and 2 grass seeds. A plurality of seeds are mixed and pelleted into a pelleted plant seed to protect seeds and improve a quality of aerial seeding afforestation and a germination rate of seeds.

### CROSS REFERENCE TO THE RELATED APPLICATIONS

This application is the national phase entry of International Application No. PCT/CN2024/081196, filed on Mar. 12, 2024, which is based upon and claims priority to Chinese Patent Application No. 202311824433.4, filed on Dec. 28, 2023, the entire contents of which are incorporated herein by reference.

### TECHNICAL FIELD

The present disclosure relates to the technical field of aerial seeding afforestation, and specifically relates to a technique for afforestation by aerial seeding of a pelleted plant seed under normal precipitation conditions.

### BACKGROUND

China has a small forest area, with a per capita forest area of merely 0.128 hm², which is only 21.3% of the world's per capita forest area of 0.6 hm². The forest cover rates of remote mountainous regions and desert hinterlands in China have been improved by the aerial seeding afforestation technology, which brings excellent ecological benefits. In recent years, a prominent progress has been made in the research work related to aerial seeding afforestation technologies. The aerial seeding afforestation technology in China has reached the international leading level. However, there is a large area of barren mountains and wastelands suitable for forest growth in China, and the desertification in northwest China is still very severe. Therefore, the task of increasing forest cover rates in the future is still arduous. The aerial seeding afforestation will still be one of the important means for afforestation during a specified period of time in the future.

The aerial seeding afforestation is an ecological construction means. In the aerial seeding afforestation, seeds are accurately broad-casted through the delivery of an aircraft to allow high-speed construction. The aerial seeding afforestation can meet the requirements of complex afforestation tasks. In the previous aerial seeding afforestation, bare seeds are directly broad-casted. The existing novel aerial seeding afforestation technology adopts seed coating and a global positioning system (GPS) to improve a quality of aerial seeding afforestation.

However, surfaces of seeds obtained by the above-mentioned seed coating include too many nutritional components and chemical reagents, and thus the long-term lack of rainfall after aerial seeding can make seeds fever to cause corrosion and damage of the seeds. After the seed coating is completed, a special drying device is required, and there is great dependence on a dryer. In addition, seeds are easily broken when falling to the ground during aerial seeding. When GPS is adopted for positioning during aerial seeding, seeds for aerial seeding may be inaccurately positioned due to drift, sunlight exposure, and pecking by birds and beasts, which makes the germination rate uncontrollable.

### SUMMARY

In view of the deficiencies of the prior art, the present disclosure provides a technique for afforestation by aerial seeding of a pelleted plant seed under normal precipitation conditions. In the technique of the present disclosure, a plurality of seeds are mixed and pelleted into a pelleted plant seed to protect the seeds and improve a quality of aerial seeding afforestation and a germination rate of the seeds.

To solve the above technical problem, the present disclosure adopts the following technical solution:

A technique for afforestation by aerial seeding of a pelleted plant seed under normal precipitation conditions is provided, including: raw material preparation, raw material treatment, pelleting, drying, screening, and aerial seeding.

The raw material preparation includes preparation of pelleted plant seed raw materials and preparation of seed raw materials.

The preparation of the pelleted plant seed raw materials includes: preparing the following raw materials in parts by volume: a red soil: 30 parts to 35 parts, a coco peat: 65 parts to 70 parts, and an organic matrix: 0 part to 5 parts;
where the red soil is a red clay collected on site in a region in which an aerial seeding operation is conducted, the red soil has a pH of 6.5 to 7, and the red soil needs to be processed into a powder before use;
the coco peat is obtained through deacidification and sterilization of a 100% natural coconut shell, and the coco peat has an electrical conductivity (EC) value of less than 0.5 ms/cm and a pH of 6.5 to 7; and
the organic matrix is a mixture of a humic substance, a camel dung, and a cow dung.

The preparation of the seed raw materials includes: selecting 6 local plant seeds according to a local environment, including 2 tree seeds, 2 shrub seeds, and 2 grass seeds.

The raw material treatment includes: crushing a red soil to 50 mesh to 100 mesh to obtain a crushed red soil; and mixing a coco peat with a matrix in advance to obtain a coco peat-based mixture.

The pelleting includes: mixing 6 local plant seeds with a crushed red soil, adding a coco peat-based mixture, and thoroughly mixing to obtain a seed-based mixture; placing the seed-based mixture in a rotary drum-type pelleting device, and pelleting in an uninterrupted discharge mode during which water is added periodically; and after the pelleting is completed, stopping the pelleting to obtain the pelleted plant seed,
where during the pelleting, a rotational speed of a rotary drum is 40 rpm;
during the periodical water addition, 200 mL of the water is added once every 2 min;
a moisture content of the pelleted plant seed is 25% to 28%; and
the plant seeds are added at 3 kg/ton of the pelleted plant seed.

The drying includes: naturally air-drying a pelleted seed, where a drying time is controlled according to light and a temperature to make a moisture content of the pelleted seed reduced to 0.5% or less.

The screening includes: screening produced pelleted seeds based on whether a diameter of a pelleted seed exceeds 2 cm to obtain a pelleted plant seed with a diameter of less than 2 cm and a pelleted plant seed with a diameter of 2 cm to 3.5 cm, where the pelleted plant seed with a diameter of less than 2 cm is adopted for a region with an average annual precipitation of less than 200 mm, and the pelleted plant seed with a diameter of 2 cm to 3.5 cm is adopted for a region with an average annual precipitation of more than 200 mm.

The aerial seeding includes: conducting an aerial seeding operation with a transport aircraft and a professional aircraft seeder, where a seeding quantity is adjusted according to a seeding density on a ground such that pelleted plant seeds are evenly sprayed in a specified operational region; a true height of an operational flight is controlled at 100 m or less, and an operational load is 750 kg; and according to a seeding density, each flight allows an operational area of 250 mu to 750 mu.

Compared with the prior art, the present disclosure has the following beneficial effects:

(1) In the present disclosure, a pelleted plant seed is prepared to avoid the defect that seeds obtained by the traditional coating technology include too many nutritional components and chemical reagents and thus the long-term lack of rainfall after aerial seeding can make seeds fever to cause corrosion and damage of the seeds. Moreover, in the present disclosure, a special drying device is not required after the coating is completed, which avoids the dependence on a dryer in the traditional coating technology. The pelleted plant seed prepared in the present disclosure can withstand a vertical force of 10 N to ensure that the pelleted plant seed will not be broken directly when falling to the ground during aerial seeding. The pelleted plant seeds obtained in the present disclosure can be screened according to different diameters and then correspondingly used for aerial seeding in regions with different precipitations. The present disclosure can allow the targeted aerial seeding for different regions to improve a survival rate of pelleted plant seeds and ensure a quality.

(2) The present disclosure not only overcomes the problems of inaccurate positioning for aerial seeding and an uncontrollable germination rate in the traditional aerial seeding operation caused by seed drift, sunlight exposure, pecking of birds and beasts, or the like, but also provides a microenvironment infinitely close to a natural environment for seed germination through the use of a red clay and a coco peat to significantly improve a germination rate of seeds and a survival rate of seedlings.

(3) In the present disclosure, a plurality of seeds are mixed, and a germination rate is improved based on the law of “survival of the fittest in natural selection” in plants. The present disclosure can increase a germination rate in a region with sufficient water and light to 82.5%, and can increase a germination rate in a region with an average annual precipitation of 100 mm to 150 mm to 39.5%. The present disclosure can also improve the biodiversity.

(4) In the present disclosure, due to mechanical properties such as cohesiveness and a strength after drying of the red soil and the coco peat, the pelleting can be allowed by processing, and dried pelleted plant seeds will not be broken when falling to the ground during an aerial seeding operation. The present disclosure can also ensure that, when the pelleted plant seeds encounter water in a desert, the red soil can provide a micro-soil environment for seed germination. As a long-fiber material, the coco peat has excellent water-absorption and water-retention properties, and can effectively prolong a demand time of seed germination for water when encountering water. In addition, long fibers of the coco peat are very conducive to pelleting with a uniform particle size. A proportion of the coco peat can be adjusted to effectively control a density of pelleted plant seeds, so as to reduce an impact force of pelleted plant seeds when falling to the ground, protect the integrity of pelleted plant seeds, and improve the distribution accuracy of pelleted plant seeds on the ground.

### DETAILED DESCRIPTION OF THE EMBODIMENTS

In order to describe the technical features, objectives, and effects of the present disclosure clearly, the specific implementations of the present disclosure are described below.

### Example 1

A technique for afforestation by aerial seeding of a pelleted plant seed under normal precipitation conditions was provided, which was specifically as follows:

1. The technique adopted the following raw materials:

(1) Pelleted plant seed raw materials: including the following raw materials in parts by volume: a red soil: 32 parts, a coco peat: 68 parts, and an organic matrix: 2 parts. The red soil was a red clay, namely, a highly-plastic clay rich in humic substances. The red soil was collected on site in a region in which an aerial seeding operation was conducted to adapt to normal conditions for seed germination of local plant seeds. The red soil had a pH of 6.5 to 7. The red soil needed to be processed into a powder before use.

The coco peat was obtained through deacidification and sterilization of a 100% natural coconut shell. The coco peat had an EC value of less than 0.5 ms/cm and a pH of 6.5 to 7.

The organic matrix was a mixture of a humic substance, a camel dung, and a cow dung, and the humic substance, the camel dung, and the cow dung were in a mass ratio of 1:1:1.

(2) Seed raw materials: Seeds were selected according to a local environment, such as Haloxylon ammodendron, Hippophae rhamnoides, Artemisia desertorum, Tamarix ramosissima, Caragana korshinskii, Alhagi sparsifolia, and Suaeda glauca seeds or other drought-tolerant and saline-alkali-tolerant plant seeds and grass seeds suitable for a local region.

2. The technique included the following steps:

(1) Raw material treatment: A red soil was crushed to 50 mesh to 100 mesh to obtain a crushed red soil. A coco peat was mixed with a matrix in advance to obtain a coco peat-based mixture.

(2) Pelleting: 6 local plant seeds were mixed with the crushed red soil, the coco peat-based mixture was added, and thorough mixing was conducted to obtain a seed-based mixture. The seed-based mixture was placed in a rotary drum-type pelleting device, and pelleting was conducted in an uninterrupted discharge mode. During the pelleting, a rotational speed of a rotary drum was controlled at 40 rpm, and 200 ml of water was added once every 2 min. After the pelleting was completed, the pelleting was stopped to obtain the pelleted plant seed.

A moisture content of the pelleted plant seed was 25% to 28%.

The 6 plant seeds included 2 tree seeds, 2 shrub seeds, and 2 grass seeds.

Specific types of plant seeds needed to be determined according to requirements of different seeds for different regional environments and climatic conditions and sizes, vitalities, and tested germination conditions of seeds. When pelleted plant seeds were prepared, it was necessary to ensure that seeds could be completely coated.

The plant seeds were added at 3 kg/ton of the pelleted plant seed.

(3) Drying: A pelleted seed was naturally air-dried. A drying time was controlled according to light and a temperature to make a moisture content of the pelleted seed reduced to 0.5% or less.

(4) Screening: Produced pelleted seeds were screened based on whether a diameter of a pelleted seed exceeded 2 cm to obtain pelleted plant seeds with a diameter of less than 2 cm and a diameter of 2 cm to 3.5 cm. A pelleted plant seed with a diameter of less than 2 cm was adopted for a region with an average annual precipitation of less than 200 mm. A pelleted plant seed with a diameter of 2 cm to 3.5 cm was adopted for a region with an average annual precipitation of more than 200 mm.

(5) Aerial seeding: An aerial seeding operation was conducted using a Yun-5-B transport aircraft with strong adaptability to an operating environment and a professional aircraft seeder. A seeding quantity was adjusted according to a seeding density on a ground such that pelleted plant seeds were evenly sprayed in a specified operational region. A true height of an operational flight was controlled at 100 m or less, and an operational load was 750 kg. According to a seeding density, each flight allowed an operational area of 250 mu to 750 mu.

### Test Example

According to the method in Example 1, aerial seeding was conducted in a region with sufficient water and light (namely, a region with an average annual precipitation of more than 200 mm) and a region with an average annual precipitation of 100 mm to 150 mm. 200 pelleted plant seeds were adopted for each aerial seeding. Germination rates on day 1 to day 10 after the aerial seeding was completed were determined, and determination results were as follows:

| | Germination time | | | | | | | | | | |
|---|---|---|---|---|---|---|---|---|---|---|---|
| | 1 d | 2 d | 3 d | 4 d | 5 d | 6 d | 7 d | 8 d | 9 d | 10 d | Germination |
| No. | Total number of germinated seeds per day | | | | | | | | | | rate (%) |
| 1 | 0 | 16 | 20 | 25 | 34 | 38 | 59 | 89 | 115 | 165 | 82.5% |
| 2 | 0 | 0 | 12 | 18 | 25 | 29 | 36 | 57 | 66 | 79 | 39.5% |

In the above table, No. 1 indicates the region with an average annual precipitation of more than 200 mm and No. 2 indicates the region with an average annual precipitation of 100 mm to 150 mm.

It can be seen from the above results that a germination rate of pelleted plant seeds can reach 82.5% in the region with sufficient water and light (namely, the region with an average annual precipitation of more than 200 mm), and a germination rate of pelleted plant seeds can reach 39.5% in the region with an average annual precipitation of 100 mm to 150 mm.

Unless otherwise specified, percentages mentioned in the present disclosure all are mass percentages.

Finally, it should be noted that the above are only preferred examples of the present disclosure and are not intended to limit the present disclosure. Although the present disclosure is described in detail with reference to the above examples, a person skilled in the art can still make modifications to the technical solutions described in the above examples, or make equivalent replacement to some technical features. Any modifications, equivalent substitutions, improvements, or the like made within the spirit and scope of the present disclosure should be included within the protection scope of the present disclosure.

What is claimed is:

1. A technique for afforestation by aerial seeding of a pelleted plant seed under normal precipitation conditions, comprising: a raw material preparation, a raw material treatment, pelleting, drying, screening, and aerial seeding.

2. The technique for afforestation by aerial seeding of the pelleted plant seed under normal precipitation conditions according to claim 1, wherein the raw material preparation comprises a preparation of pelleted plant seed raw materials and a preparation of seed raw materials.

3. The technique for afforestation by aerial seeding of the pelleted plant seed under normal precipitation conditions according to claim 2, wherein the preparation of the pelleted plant seed raw materials comprises: preparing the following raw materials in parts by volume: a red soil: 30 parts to 35 parts, a coco peat: 65 parts to 70 parts, and an organic matrix: 0 part to 5 parts;
wherein the red soil is a red clay collected on site in a region, an aerial seeding operation is conducted in the region, the red soil has a pH of 6.5 to 7, and the red soil is processed into a powder before use;
the coco peat is obtained through deacidification and sterilization of a 100% natural coconut shell, and the coco peat has an electrical conductivity (EC) value of less than 0.5 ms/cm and a pH of 6.5 to 7; and
the organic matrix is a mixture of a humic substance, a camel dung, and a cow dung.

4. The technique for afforestation by aerial seeding of the pelleted plant seed under normal precipitation conditions according to claim 2, wherein the preparation of the seed raw materials comprises: selecting 6 local plant seeds according to a local environment, comprising 2 tree seeds, 2 shrub seeds, and 2 grass seeds.

5. The technique for afforestation by aerial seeding of the pelleted plant seed under normal precipitation conditions according to claim 1, wherein the raw material treatment comprises: crushing a red soil to 50 mesh to 100 mesh to obtain a crushed red soil; and mixing a coco peat with a matrix in advance to obtain a coco peat-based mixture.

6. The technique for afforestation by aerial seeding of the pelleted plant seed under normal precipitation conditions according to claim 1, wherein the pelleting comprises: mixing 6 local plant seeds with a crushed red soil, adding a coco peat-based mixture, and thoroughly mixing to obtain a seed-based mixture; placing the seed-based mixture in a rotary drum-type pelleting device, and pelleting in an uninterrupted discharge mode, conducting a periodical water addition during the pelleting; and after the pelleting is completed, stopping the pelleting to obtain the pelleted plant seed,
wherein during the pelleting, a rotational speed of a rotary drum is 40 rpm;
during the periodical water addition, 200 mL of the water is added once every 2 min;
a moisture content of the pelleted plant seed is 25% to 28%; and
the 6 local plant seeds are added at 3 kg/ton of the pelleted plant seed.

7. The technique for afforestation by aerial seeding of the pelleted plant seed under normal precipitation conditions according to claim 1, wherein the drying comprises: naturally air-drying a pelleted seed, wherein a drying time is controlled according to light and a temperature to make a moisture content of the pelleted seed reduced to 0.5% or less.

8. The technique for afforestation by aerial seeding of the pelleted plant seed under normal precipitation conditions according to claim 1, wherein the screening comprises: screening produced pelleted seeds based on whether a diameter of a pelleted seed exceeds 2 cm to obtain a pelleted plant seed with a diameter of less than 2 cm and a pelleted plant seed with a diameter of 2 cm to 3.5 cm, wherein the pelleted plant seed with the diameter of less than 2 cm is adopted for a region with an average annual precipitation of less than 200 mm, and the pelleted plant seed with the diameter of 2 cm to 3.5 cm is adopted for a region with an average annual precipitation of more than 200 mm.

9. The technique for afforestation by aerial seeding of the pelleted plant seed under normal precipitation conditions according to claim 1, wherein the aerial seeding comprises: conducting an aerial seeding operation with a transport aircraft and a professional aircraft seeder, wherein a seeding quantity is adjusted according to a seeding density on a ground such that the pelleted plant seeds are evenly sprayed in a specified operational region; a true height of an operational flight is controlled at 100 m or less, and an operational load is 750 kg; and according to the seeding density, each flight allows an operational area of 250 mu to 750 mu.
